(19) United States
(12) Patent Application Publication
(10) Pub. No.: US 2026/0148049 A1
(43) Pub. Date: May 28, 2026

(54) GENERAL ANALYSIS METHOD AND SYSTEM FOR BIMODAL MULTITASK SPATIOTEMPORAL DATA

(71) Applicant: BEIHANG UNIVERSITY, BEIJING (CN)

(72) Inventors: JINGYUAN WANG, BEIJING (CN); XIE YU, BEIJING (CN); YIFAN YANG, BEIJING (CN); WENRUI WANG, BEIJING (CN)

(21) Appl. No.: 19/402,066

(22) Filed: Nov. 26, 2025

(30) Foreign Application Priority Data
Nov. 27, 2024 (CN) 202411710488.7

(51) Int. Cl. G06N 3/0499; G06F 18/213; G06F 18/27; G06F 40/284; G06F 123/02; G06N 3/092

(52) U.S. Cl. CPC G06N 3/0499; G06F 18/213; G06F 18/27; G06F 40/284; G06N 3/092; G06F 2123/02

(57) ABSTRACT

The present invention discloses a general analysis method and system for bimodal multitask spatiotemporal data. The method includes acquiring spatiotemporal data of different modalities; transforming the spatiotemporal data of different modalities into data sequences of a same format, and generating a road network representation vector based on the spatiotemporal data of different modalities; upsampling the data sequences and the road network representation vector to obtain spatiotemporal data feature sequences; and determining textual instructions and task placeholders, combined with the spatiotemporal data feature sequences, to analyze the spatiotemporal data by using a spatiotemporal data analysis model. The present invention effectively solves the problem of incompatibility between different data modalities and can flexibly adapt to the requirements of different tasks.

### TECHNICAL FIELD

The present invention relates to the technical field of data analysis, and more specifically, to a general analysis method and system for bimodal multitask spatiotemporal data.

### BACKGROUND

Spatiotemporal data analysis has been widely used in the fields of intelligent transportation systems (ITS), smart cities, and location-based services (LBS). Existing spatiotemporal data analysis methods mainly target specific tasks, limiting the generalization capability of a model across tasks.

Currently, multitask general deep learning models have achieved significant success in the fields of natural language processing (NLP), computer vision (CV), and multimedia (MM), but still face many challenges in the field of spatiotemporal data analysis, including:
1) Challenge of constructing a unified representation of spatiotemporal data: Two types of important data in spatiotemporal data analysis, i.e., individual trajectories and group traffic states, are often regarded as two incompatible data modalities. Trajectory data is usually represented as a sequence of geographic units, such as road segments or points of interest (POI), while traffic state data is represented as a graph structure with dynamic signals (such as traffic speed). How to unify the representations of the two different modalities of data is a challenge.

Existing methods generally support various downstream tasks by constructing a general spatiotemporal data representation. However, most of these methods focus on individual static geographic elements, such as road networks and POI, or only focus on trajectory data.

In recent years, trajectory representation models such as TremBR and START propose introducing periodicity of temporal information, and traffic state models such as T-wave, TrajNet, and TrGNN capture multi-hop spatial dependencies by propagating information along trajectories. Although the current representation models overlap in the fields of trajectories and traffic states, developing a unified representation perspective for the two types of data remains an unresolved research field;
2) Challenge of unifying heterogeneous spatiotemporal data analysis tasks: Spatiotemporal data analysis tasks are highly heterogeneous, including:
   Different data formats of different tasks: For example, the output of a travel time estimation task is continuous time, while the output of a path planning task is another trajectory;
   Significant differences in complexity of heterogeneous tasks: Supervisory signals require annotations of different granularities, resulting in diverse training formats.
   Existing general models call dedicated models as tools for cross-task learning during training. This pattern constructs a general spatiotemporal data analysis system rather than a single model, and this system has limited capability in revealing correlations between different tasks.

Therefore, it is still a major challenge to develop a general single model that can simultaneously process trajectory and traffic state data and analyze spatiotemporal data across multiple heterogeneous tasks.

### SUMMARY

In view of this, in order to at least partially solve the above technical problems, the present invention provides a general analysis method and system for bimodal multitask spatiotemporal data, aiming to achieve cross-dataset generalization based on traffic spatiotemporal data, and process various tasks based on spatiotemporal data, thereby achieving analysis and prediction of a traffic state.

In order to achieve the above objectives, the present invention adopts the following technical solutions:
In a first aspect, the present application discloses a general analysis method for bimodal multitask spatiotemporal data, including:
   acquiring spatiotemporal data of different modalities;
   transforming the spatiotemporal data of different modalities into data sequences of a same format, and generating a road network representation vector based on the spatiotemporal data of different modalities;
   extracting corresponding spatiotemporal data feature sequences from the road network representation vector with the data sequences as indexes; and
   determining textual instructions and task placeholders, combined with the spatiotemporal data feature sequences, to analyze the spatiotemporal data by using a spatiotemporal data analysis model.

Further, the spatiotemporal data comes from a road network of a to-be-analyzed area, and each node in the road network includes static road trajectory information and dynamic traffic states.

Further, a sequence format is: [geographic location, instantaneous time index, state interval index];
where the geographic location refers to a specific road segment currently located, the instantaneous time refers to current time, and the state interval refers to statistically derive traffic state information within a preset time interval.

Further, the step of generating a road network representation vector based on the spatiotemporal data of different modalities includes:
extracting static and dynamic road network features from the spatiotemporal data of different modalities through tokenizers, and concatenating the static and dynamic road network features;
determining K and V values based on the concatenated features, and combining the K and V values with a learnable Q value to output attention weighted features through a cross attention mechanism; and
further performing feature extraction on the attention weighted features through a multi-layer perceptron (MLP) network to obtain the road network representation vector.

Further, the tokenizer includes a first fully-connected feedforward (FFN) network, a graph attention (GAT) network, and a second FFN network connected in sequence.

Further, the task placeholders include classification and regression placeholders.

Further, the spatiotemporal data analysis model is trained with a hierarchical training strategy, including the following steps:
pretraining the spatiotemporal data analysis model based on the spatiotemporal data feature sequences and the task placeholders;
incorporating textual instructions to tune the spatiotemporal data analysis model; and
introducing reinforcement learning to enhance the performance of the spatiotemporal data analysis model.

Further, the spatiotemporal data analysis model is formed by stacking a plurality of Blocks, including a Value network, a Query network, and a Key network that are parallel, where output terminals of the networks are jointly connected to a multi head attention network, and an output terminal of the multi head attention network is sequentially connected to a normalization layer and a feedforward neural network.

In a second aspect, the present application discloses a general analysis system for bimodal multitask spatiotemporal data, the system using the general analysis method for bimodal multitask spatiotemporal data as described above, and the system including:
a data acquisition module, configured to acquire spatiotemporal data of different modalities;
a format transformation module, configured to transform the spatiotemporal data of different modalities into data sequences of a same format;
a road network representation vector generation module, configured to generate a road network representation vector based on the spatiotemporal data of different modalities;
a spatiotemporal data feature sequence extraction module, configured to extract the road network representation vector with the data sequences as indexes; and
a spatiotemporal data analysis module, configured to analyze the spatiotemporal data by using a spatiotemporal data analysis model based on textual instructions and task placeholders, combined with spatiotemporal data feature sequences.

Further, the system further includes a spatiotemporal data analysis model training module, configured to train the spatiotemporal data analysis model with a hierarchical training strategy, including the following steps:
pretraining the spatiotemporal data analysis model based on the spatiotemporal data feature sequences and the task placeholders;
incorporating textual instructions to tune the spatiotemporal data analysis model; and
introducing reinforcement learning to enhance the performance of the spatiotemporal data analysis model.

According to the above technical solutions, the general analysis method and system for bimodal multitask spatiotemporal data, disclosed in the present invention, mainly achieve unified representation of spatiotemporal data of different modalities through spatiotemporal units (ST units) and spatiotemporal tokenizers, and introduce interactive prompts and a hierarchical training strategy to address the challenges of task heterogeneity.

Compared with the prior art, the present invention has the following advantages:
1. The present invention successfully constructs a unified spatiotemporal data representation framework by transforming individual trajectory and group traffic state data into data sequences of a same format and generating a road network representation vector. This framework effectively solves the problem of incompatibility between different data modalities, enabling two types of data to be analyzed on a common basis.
2. Different from a general model called as a tool in the prior art, the spatiotemporal data analysis model proposed by the present invention can directly process multiple heterogeneous tasks, such as classification and regression, so a dedicated model is not required to design for each task, and correlations between different spatiotemporal data analysis tasks can be revealed. The combination of task placeholders and textual instructions enables the model to flexibly adapt to the requirements of different tasks, greatly improving task processing efficiency.
3. The hierarchical training strategy, including pretraining, tuning, and reinforcement learning, significantly improves the generalization capability of the model, and enables the model to perform well on specific datasets and maintain high performance across datasets.

### BRIEF DESCRIPTION OF THE DRAWINGS

In order to explain the technical solutions in the embodiments of the present invention or in the prior art more clearly, the accompanying drawings required for use in the description of the embodiments or the prior art will be briefly introduced below. Apparently, the drawings described below merely illustrate the embodiments of the present invention. For those of ordinary skill in the art, other drawings can be derived from the provided drawings without any creative efforts.

FIG. 1 is a schematic flowchart of a general analysis method for bimodal multitask spatiotemporal data;

FIG. 2 is a schematic structural diagram of an ST Tokenizer;

FIG. 3 shows an example of input data for a trajectory generation task;

FIG. 4 is a schematic diagram of a three-stage training method;

FIG. 5 shows corresponding relationships between data, models, and tasks for spatiotemporal analysis using current baseline models; and

FIG. 6 shows relationships between data, a model, and tasks obtained using a solution of the present invention.

### DETAILED DESCRIPTION

The technical solutions in the embodiments of the present invention will be clearly and completely described below in combination with the accompanying drawings in the embodiments of the present invention. Apparently, the described embodiments are merely some of the embodiments of the present invention, not all of them. Based on the embodiments of the present invention, all other embodiments obtained by those of ordinary skill in the art without any creative efforts fall within the scope of protection of the present invention.

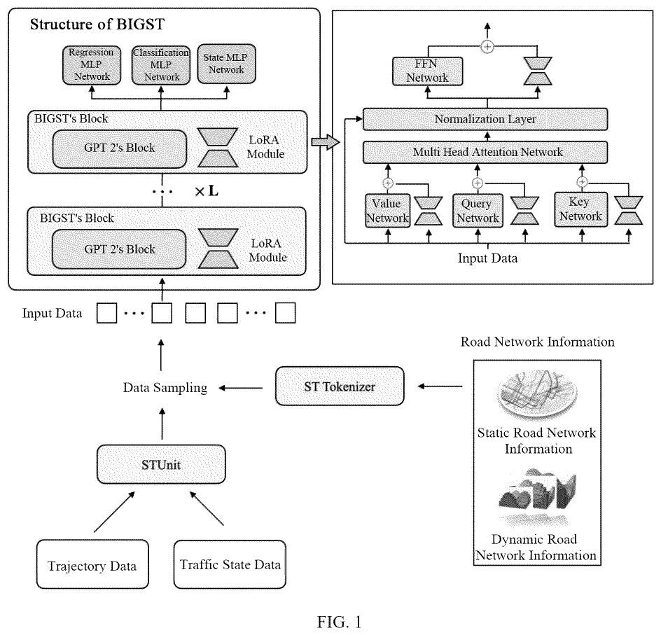

In order to overcome the above problems in the prior art, an embodiment of the present invention first discloses a general analysis method for bimodal multitask spatiotemporal data. Refer to FIG. 1. FIG. 1 is a schematic flowchart of a general analysis method for bimodal multitask spatiotemporal data.

The analysis method includes the following steps:
S1. Acquire spatiotemporal data of different modalities. In one embodiment, the analysis method is used to process common spatiotemporal applications based on road networks, including trajectory and traffic state tasks. In a dataset of the present application, all heterogeneous spatiotemporal data come from a road network of a to-be-analyzed area, where the network is constructed as a graph structure, with each node including static road trajectory information and dynamic traffic states.
S2. Transform the spatiotemporal data of different modalities into data sequences of a same format, and generate a road network representation vector based on the spatiotemporal data of different modalities.

In the present application, both trajectory data and traffic state data are essentially sequence data sampled from a dynamic road network. From this perspective, the trajectory data and the traffic state data mainly differ in their sampling methods.

Therefore, in one embodiment, in response to the challenge of unified data representation, the present application proposes spatiotemporal units (ST units) for transforming spatiotemporal data of trajectory and traffic state sequences, two different modalities, into a unified format. That is, the spatiotemporal data of the two modalities can be represented as ST unit sequences.

The ST unit sequence is a data format. Specifically,

A format structure is: [Geographic location, instantaneous time index, state interval index].

The geographic location refers to a specific road segment currently located, and the instantaneous time refers to current time accurate to seconds. The state interval is used to measure a traffic state, with half-hour intervals, to statistically derive traffic state information within that time frame.

In another embodiment, the present application designs a spatiotemporal tokenizer (ST tokenizer) for generating a road network representation vector based on spatiotemporal data of different modalities, where the road network representation vector is a graph structure used to represent a dynamic road network;

The generation steps include:
extracting static and dynamic road network features from the spatiotemporal data of different modalities through tokenizers, and concatenating the static and dynamic road network features;
determining K and V values based on the concatenated features, and combining the K and V values with a learnable Q value to output attention weighted features through a cross attention mechanism; and
further performing feature extraction on the attention weighted features through an MLP network to obtain the road network representation vector.

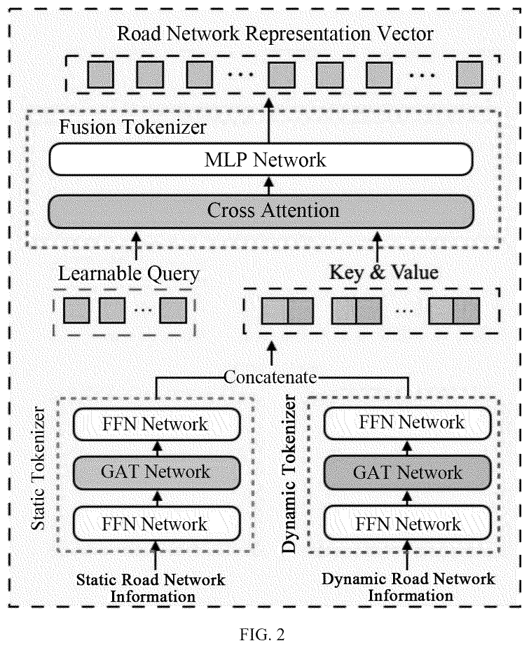

In one embodiment, the structure of the ST tokenizer is shown in FIG. 2, where a static tokenizer, a dynamic tokenizer, and a fusion tokenizer are shown;

The static tokenizer and the dynamic tokenizer have the same structure, including a first FFN network, a GAT network, and a second FFN network connected in sequence. The present invention can achieve deep fusion of spatiotemporal data through the tokenizers. Such fusion not only enhances the comprehensiveness of data analysis, but also improves the explanatory power and prediction accuracy of a model.

The first FFN network (fully-connected feedforward network) is configured to preliminarily process static road network information and extract features;

The GAT network (graph attention network) is configured to capture spatial dependencies in the road network and emphasize important road segment features;

The second FFN network (fully-connected feedforward network) is configured to further process and abstract the features output by the GAT network.

The features processed by the static tokenizer and the dynamic tokenizer are further concatenated to form a richer feature representation, which helps the model better understand the overall situation of the road network.

The K and V values are further determined based on the concatenated features and combined with the learnable Q value to output the attention weighted features through the cross attention mechanism. The K (Key) and V (Value) values represent important parts of road network features, and are subjected to interactive attention calculation with the learnable Q value to determine the importance of different features.

The fusion tokenizer includes a cross attention and an MLP network;
The cross attention is used for calculating a similarity between Q and K to obtain an importance weight of each feature, and then performing weighted summation with the V value to obtain a final attention weighted feature;
The MLP network is configured to process the features output by the cross attention mechanism, further extract and abstract information, and finally output a road network representation vector. This vector may be a comprehensive representation of the entire road network or an intermediate representation used for a specific prediction task.

In this embodiment, the ST tokenizer can effectively capture complex relationships of the road network and provide powerful feature support for subsequent road network analysis or prediction tasks by combining static and dynamic information and utilizing the graph neural network and the attention mechanism.

In one embodiment, learnable Q is a trainable variable, i.e., a loss is calculated through attention output and label calculation, then a gradient of the loss relative to Q is calculated, and parameters of Q are updated through an optimization algorithm. The learnable Q enables the model to extract useful information from the input features more effectively.
S3. Acquire corresponding data from the road network representation vector with the data sequences as indexes to obtain spatiotemporal data feature sequences.

In this embodiment, the spatiotemporal data of different modalities may be sampled in different ways. Specifically, the data sequences formed by trajectory and traffic data provide data indexes, and spatiotemporal feature information is extracted from dynamic road network representations based on the indexes to obtain a unified representation of trajectory and traffic states (spatiotemporal data feature sequences).
S4. Determine textual instructions and task placeholders, combined with the spatiotemporal data feature sequences, to analyze the spatiotemporal data by using a spatiotemporal data analysis model.

This embodiment challenges task heterogeneity by introducing interactive prompts, i.e., uniformly labeling specific task data from different heterogeneous tasks, including input data and task related specifications.

For input data, based on the spatiotemporal data feature sequences, the present application adds textual instructions to guide the model to execute task types;

For output tasks, because multiple tasks may share the same spatiotemporal input, it is difficult for the model to determine specific task types based solely on the spatiotemporal data. Therefore, to address this challenge, the present application introduces a task instruction mechanism as a task identifier to indicate the output type and quantity of each task. On this basis, data from multiple spatiotemporal tasks may be integrated into one dataset for joint training.

In one embodiment, spatiotemporal tasks are classified into four categories, and their output forms are summarized into two categories: classification of static road segment IDs and regression of dynamic features.

As a preferred solution, the task placeholders are defined as [CLS] for classification and [REG] for regression.

In one exemplary embodiment, a personalized textual instruction template is provided for each task to clarify a task type. In this way, the formats of all input data can be unified. Specifically, the input of the model is divided into three parts: textual instructions, spatiotemporal data feature sequences, and task placeholders.

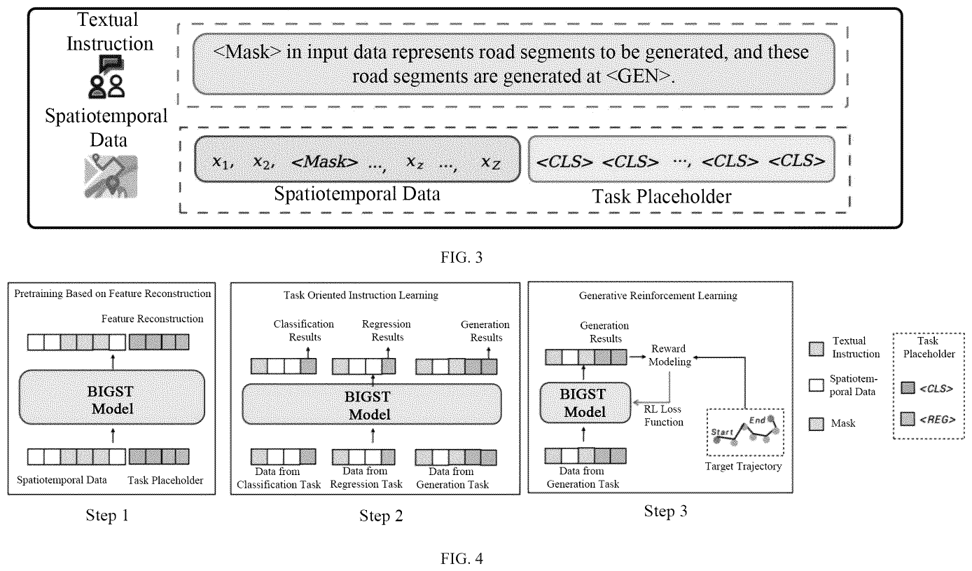

To further illustrate the relations between textual instructions, spatiotemporal data, and task placeholders, the present application provides a specific input data example based on a trajectory generation task, as shown in FIG. 3.

In one embodiment, heterogeneous tasks are different in complexity and training paradigms. For example, generation tasks output sequences and use sequence labels for supervision, while classification and regression tasks rely on a single label for supervision. To address these challenges, the present application designs a three-stage training process to meet the requirements of tasks of different complexities, including trajectory reconstruction during model pretraining; tuning of task oriented prompts to adapt the model to tasks; and generative reinforcement learning to enhance the performance of trajectory generation tasks. With reference to FIG. 4, specific training steps include:
1) Pretrain the spatiotemporal data analysis model based on the spatiotemporal data feature sequences and the task placeholders;

At this stage, only the spatiotemporal data (ST data) and the task placeholders are used for training. Specifically, the input of the model is divided into three parts: textual instructions, spatiotemporal data, and task placeholders. For the output of the model, only the task placeholders are taken as final results. The quantity of task placeholders corresponds one to one with the quantity of results that the model needs to output. Regression tasks are obtained through regression placeholders ([REG]), while classification tasks are obtained through classification placeholders ([CLS]);
2) Incorporate textual instructions to tune the spatiotemporal data analysis model. With the help of textual instructions, the model is jointly tuned on multiple tasks. After this stage, the model can process classification and regression tasks.

As the input data of all tasks are unified into textual instructions+spatiotemporal data+task placeholders, all the tasks can be trained uniformly through a set of model architecture. Each type of tasks has its textual instruction template as a specific task identifier.
3) Introduce reinforcement learning to enhance the performance of the spatiotemporal data analysis model.

The final stage introduces reinforcement learning specifically to enhance the performance of the model on sequence labeling tasks (such as generation tasks).

This embodiment employs a proximal policy optimization (PPO) algorithm in reinforcement learning, including:
Firstly, the distance between a generated trajectory and a truth trajectory is calculated through dynamic time warping (DTW). This distance calculation method assigns a distance value to each token in the trajectory. Afterwards, these distance values are accumulated to generate a reward value in reinforcement learning, and then a loss value in reinforcement learning is obtained.

In the present application, all tasks can be trained through sequence modeling. Given the powerful capability of GPT-2 in sequence modeling, it can be used as an infrastructure for building the spatiotemporal data analysis model.

In one embodiment, the spatiotemporal data analysis model is a bimodal interactive general symmetric transformer (BIGST) used for spatiotemporal data analysis, and the model architecture of BIGST is shown in FIG. 1.

BIGST includes multiple stacked Blocks to learn complex sequence-to-sequence mappings. The Blocks include a Value network, a Query network, and a Key network that are parallel, where output terminals of the networks are jointly connected to a multi head attention network, and an output terminal of the multi head attention network is sequentially connected to a normalization layer and a feedforward neural network. The architecture design of the present invention is efficient and can capture long-distance spatiotemporal dependencies, thereby improving the calculation efficiency and prediction accuracy of the model.

Among them:
Value network: configured to extract “Value” information from input data;
Query network: configured to extract “Query” information from input data;
Key network: configured to extract “Key” information.

The three networks are usually fully-connected layers that process input data in parallel to generate corresponding value, query, and key vectors.

In the multi head attention network, the outputs from the Q, K, and V networks will be divided into multiple “heads”, each head calculating a portion of attention output. The final output of the multi head attention network is a concatenated output of all heads, which can capture the relationships between different portions of input sequences.

After the multi head attention network, the output data is normalized through a normalization layer, which normalizes each feature of each sample to stabilize the training process and accelerate convergence.

Then, the feedforward neural network (FFN network) further processes the features that have undergone multi head attention and layer normalization, increasing the nonlinearity of the model.

In this embodiment, there are residual connections (skip connections) between the multi head attention network and the FFN network, as well as after the FFN network. These connections directly add the input data to the output of each submodule, thereby preventing gradient vanishing problems and allowing the model to train deeper networks.

In an implementable embodiment, the present application discloses a general analysis system for bimodal multitask spatiotemporal data, the system using the general analysis method for bimodal multitask spatiotemporal data as described above, where the system includes:
a data acquisition module, configured to acquire spatiotemporal data of different modalities;
a format transformation module, configured to transform the spatiotemporal data of different modalities into data sequences of a same format;
a road network representation vector generation module, configured to generate a road network representation vector based on the spatiotemporal data of different modalities;
a spatiotemporal data feature sequence extraction module, configured to extract the road network representation vector with the data sequences as indexes; and
a spatiotemporal data analysis module, configured to analyze the spatiotemporal data by using a spatiotemporal data analysis model based on textual instructions and task placeholders, combined with spatiotemporal data feature sequences.

Further, the system includes a spatiotemporal data analysis model training module, configured to train the spatiotemporal data analysis model with a hierarchical training strategy, including the following steps:
pretraining the spatiotemporal data analysis model based on the spatiotemporal data feature sequences and the task placeholders;
incorporating textual instructions to tune the spatiotemporal data analysis model; and
introducing reinforcement learning to enhance the performance of the spatiotemporal data analysis model.

The detailed execution steps of the system are consistent with those of the foregoing general analysis method for bimodal multitask spatiotemporal data, and therefore, will not be repeated here.

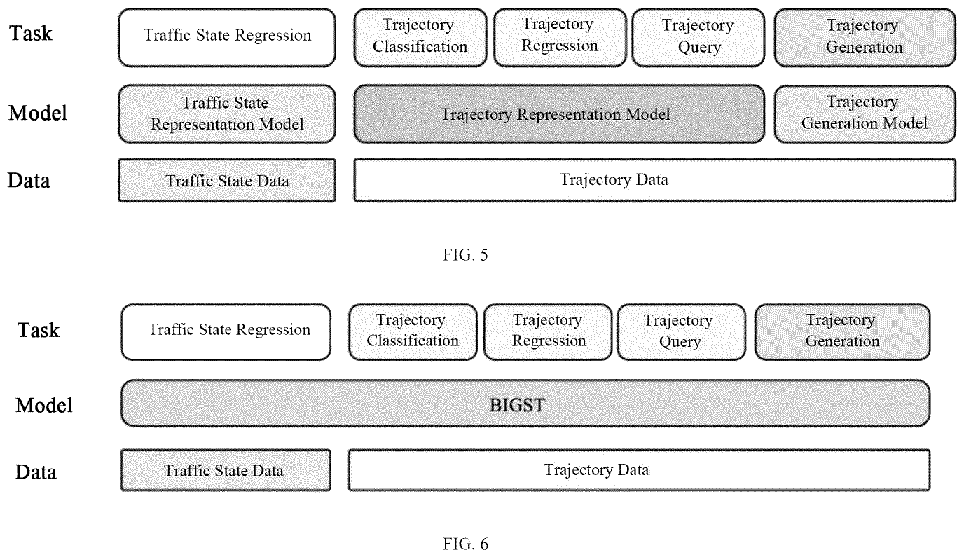

The general analysis method for bimodal multitask spatiotemporal data in the present application can integrate multiple data types and simultaneously process multiple tasks. In order to clarify the effects achievable by the present application, the three different baseline models are further compared. The dataset, model, and task corresponding to each baseline model are shown in FIG. 5.

As shown in FIG. 5, in existing methods, three baselines are different in model architecture and training paradigm. Further, the method or system of the present application is utilized to simultaneously process these different tasks, and the obtained relationships between the data, models, and tasks are shown in FIG. 6.

As shown in FIG. 6, the advantage of the present application lies in its powerful multitask capability, and the BIGST can process three different baselines and achieve state-of-the-art (SOTA) performance.

The present invention has achieved significant technological breakthroughs in the field of spatiotemporal data analysis, provides powerful analysis tools for intelligent transportation systems, urban planning, and other related fields, and has broad application prospects and significant technical advantages.

The embodiments are described progressively, each embodiment emphasizes its differences from other embodiments, and the same and similar parts between the embodiments can be referred to each other. The system disclosed in the embodiments corresponds to the method disclosed in the embodiments and is thus described relatively simply, and reference may be made to the description of the method for related parts.

The above descriptions of the disclosed embodiments enable those skilled in the art to implement or use the present invention. Various modifications to these embodiments are obvious to those skilled in the art, and the general principles defined herein may be implemented in other embodiments without departing from the spirit or scope of the present invention. Therefore, the present invention will not be limited to the embodiments described herein, but extends to the widest scope that complies with the principle and novelty disclosed herein.

1. A general analysis method for bimodal multitask spatiotemporal data, comprising:
acquiring spatiotemporal data of different modalities, wherein the spatiotemporal data comes from a road network of a to-be-analyzed area, and each node in the road network comprises static road trajectory information and dynamic traffic states;
transforming the spatiotemporal data of different modalities into data sequences of a same format, wherein a sequence format is: [geographic location, instantaneous time index, state interval index, the geographic location refers to a specific road segment currently located, the instantaneous time refers to current time, and the state interval refers to statistically derive traffic state information within a preset time interval;
generating a road network representation vector based on the spatiotemporal data of different modalities, wherein the generating the road network representation vector based on the spatiotemporal data of different modalities comprises:
extracting static and dynamic road network features from the spatiotemporal data of different modalities through tokenizers, and concatenating the static and dynamic road network features, wherein the tokenizer comprises a first FFN network, a GAT network, and a second FFN network connected in sequence;
determining K and V values based on the concatenated features, and combining the K and V values with a learnable Q value to output attention weighted features through a cross attention mechanism; and
further performing feature extraction on the attention weighted features through an MLP network to obtain the road network representation vector;
extracting corresponding spatiotemporal data feature sequences from the road network representation vector with the data sequences as indexes; and
determining textual instructions and task placeholders, combined with the spatiotemporal data feature sequences, to analyze the spatiotemporal data by using a spatiotemporal data analysis model, wherein the textual instructions are textual instructions for guiding the model to execute task types, the task placeholders comprise classification and regression placeholders, the spatiotemporal data analysis model is formed by stacking a plurality of Blocks, comprising a Value network, a Query network, and a Key network that are parallel, wherein output terminals of the networks are jointly connected to a multi head attention network, and an output terminal of the multi head attention network is sequentially connected to a normalization layer and a feedforward neural network.

2-6. (canceled)

7. The general analysis method for bimodal multitask spatiotemporal data according to claim 1, wherein the spatiotemporal data analysis model is trained with a hierarchical training strategy, comprising the following steps:
pretraining the spatiotemporal data analysis model based on the spatiotemporal data feature sequences and the task placeholders;
incorporating textual instructions to tune the spatiotemporal data analysis model; and
introducing reinforcement learning to enhance the performance of the spatiotemporal data analysis model.

8. (canceled)

9. A general analysis system for bimodal multitask spatiotemporal data, using the general analysis method for bimodal multitask spatiotemporal data according to claim 1, the system comprising:
a data acquisition module, configured to acquire spatiotemporal data of different modalities;
a format transformation module, configured to transform the spatiotemporal data of different modalities into data sequences of a same format;
a road network representation vector generation module, configured to generate a road network representation vector based on the spatiotemporal data of different modalities;
a spatiotemporal data feature sequence extraction module, configured to extract the road network representation vector with the data sequences as indexes; and
a spatiotemporal data analysis module, configured to analyze the spatiotemporal data by using a spatiotemporal data analysis model based on textual instructions and task placeholders, combined with spatiotemporal data feature sequences.

10. The general analysis system for bimodal multitask spatiotemporal data according to claim 9, further comprising a spatiotemporal data analysis model training module, configured to train the spatiotemporal data analysis model with a hierarchical training strategy, comprising the following steps:
pretraining the spatiotemporal data analysis model based on the spatiotemporal data feature sequences and the task placeholders;
incorporating textual instructions to tune the spatiotemporal data analysis model; and
introducing reinforcement learning to enhance the performance of the spatiotemporal data analysis model.
